(19) United States
(12) Patent Application Publication
(10) Pub. No.: US 2017/0033728 A1
(43) Pub. Date: Feb. 2, 2017

(54) MOTOR CONTROL DEVICE CAPABLE OF MEASURING TEMPERATURE OF ROTOR AND MOTOR PROVIDED THEREWITH

(71) Applicant: FANUC CORPORATION, Yamanashi (JP)

(72) Inventor: Fumito Yukawa, Yamanashi (JP)

(73) Assignee: FANUC CORPORATION, Yamanashi (JP)

(21) Appl. No.: 15/220,673

(22) Filed: Jul. 27, 2016

(30) Foreign Application Priority Data
Jul. 30, 2015 (JP) 2015-151120

(51) Int. Cl. H02P 29/60; H02K 11/25

(52) U.S. Cl. CPC H02P 29/60; H02K 11/25

(57) ABSTRACT

The motor control device of the present invention comprises a sensor gear expansion amount estimation part which estimates the amount of expansion of a sensor gear, a sensor mount expansion amount estimation part which estimates the amount of expansion of a sensor mount, a sensor gear expansion amount correction part which corrects the estimated amount of expansion of the sensor gear, and a rotor temperature estimation part which estimates the temperature of the rotor based on the corrected sensor gear expansion amount of the sensor gear.

### BACKGROUND OF THE INVENTION

1. Field of the Invention

The present invention is related to a motor control device which controls a motor while monitoring the temperature thereof, and a motor provided with the motor control device.

2. Related Art

When a motor is operated, the temperature of the rotor of the motor increases to a certain temperature. While the temperature of the rotor increases in this way, even if the command given to the motor is the same, the output of the motor may change. In a machine tool which drives a tool by a rotor of a motor, there is a risk that the change in output of the motor in accordance with the temperature change of the rotor may influence the machining quality of the machine tool. Therefore, technology for estimating the temperature of the rotor in a motor of a machine tool is being investigated. Namely, it is capable of controlling a motor based on the estimated temperature of the rotor so that the output of the motor is stable with the same command.

As such technology for estimating the temperature of a rotor, that is, a rotating body, Japanese Patent Application Laid-open No. 2008-170354 discloses a temperature estimation device for estimating the temperature or the change in temperature of a brake of the wheels of an automobile or other vehicles.

The temperature estimation device of Japanese Patent Application Laid-open No. 2008-170354, is provided with a signal generating means installed on a non-rotating portion spaced from a rotating body which rotates with a wheel. The signal generating means generates signals which change in response to distances from the rotating body. When the rotating body expands due to heat, the distance between the signal generating means and the rotating body changes. The amount of change of the separation can be considered to correspond to the thermal expansion of the rotating body. Further, the temperature estimation device described in Japanese Patent Application Laid-open No. 2008-170354 acquires the thermal expansion of the rotating body from the change in strength of the signal generated by the signal generation means, and based on the thermal expansion, the temperature rise is estimated.

However, if the temperature estimation device described in Japanese Patent Application Laid-open No. 2008-170354 is applied to a motor, the following problem arises. In case of a motor, the temperature of the whole motor rises with the rise in temperature of the rotor, and therefore, not only the rotor, but also the mounting part of the signal generating means expand due to heat. Accordingly, even if the temperature of the rotor is estimated based on the change in strength of the signal generated by the signal generating means by the temperature estimation device described in Japanese Patent Application Laid-open No. 2008-170354, the estimated temperature of the rotor is not correct. Namely, in the temperature estimation device described in Japanese Patent Application Laid-open No. 2008-170354, the thermal expansion of the mounting part of the signal generating means is not taken into account when estimating the temperature of the rotating body. Therefore, in the temperature estimation device described in Japanese Patent Application Laid-open No. 2008-170354, the temperature of the rotor is not correct, and therefore the output of the motor following the same command may not be stable.

Further, on considering accurately measuring the temperature of a rotor by a different method, it is difficult to directly contact the rotating rotor with a thermometer because the rotor is a rotating body. Thus a method of measuring the temperature without contact, by using infrared radiation was considered. However, it is necessary to separately install the infrared temperature measurement device to the motor, and consequently the cost will greatly increase. Further, there is the problem that only the surface temperature of an object to be measured can be measured by the infrared radiation.

### SUMMARY OF THE INVENTION

The present invention provides a motor control device in which the temperature of a rotor can be easily and accurately estimated, and a motor provided with the same.

According to a first aspect of the present invention, there is provided a motor control device controlling a motor which comprises a sensor gear mounted to a rotor of the motor, a magnetic sensor which detects the presence/absence of each of a plurality of teeth provided successively at predetermined intervals on the outer periphery of the sensor gear as signals, a sensor mount to which the magnetic sensor is mounted; and a temperature detector which detects the temperature of the sensor mount, wherein the motor control device comprises a sensor gear expansion amount estimation part which estimates the amount of expansion of the sensor gear based on the amount of change in the strength of the output signal of the magnetic sensor, a sensor mount expansion amount estimation part which estimates the amount of expansion of the sensor mount based on the temperature detected by the temperature detector, a sensor gear expansion amount correction part which corrects the estimated expansion of the sensor gear by subtracting the estimated expansion amount of the sensor mount from the estimated expansion amount of the sensor gear, and a rotor temperature estimation part which estimates the temperature of the rotor based on the corrected expansion amount of the sensor gear.

According to a second aspect of the present invention, there is provided the motor control device of the first aspect further comprising a sensor output signal correction part which corrects the strength of the output signal of the magnetic sensor based on the temperature detected by the temperature detector, wherein the sensor gear expansion amount estimation part is configured to estimate the expansion amount of the sensor gear based on the amount of change in the strength of the output signal of the magnetic sensor corrected by the sensor output signal correction part.

According to a third aspect of the present invention, there is provided the motor control device of the first or second aspect, wherein the sensor gear expansion amount correction part is configured to correct the estimated amount of expansion of the sensor gear by subtracting the expansion amount due to the centrifugal force on the sensor gear corresponding to the rotational speed of the rotor and the estimated amount of expansion of the sensor mount, from the estimated amount of expansion of the sensor gear.

According to a fourth aspect of the present invention, there is provided the motor control device of the third aspect, wherein the rotational speed of the rotor is calculated based on the frequency of the output signal of the magnetic sensor, and the sensor gear expansion amount correction part is configured to store and hold a table indicating the correlation between the expansion amount due to the centrifugal force on the sensor gear and the rotational speed of the rotor, the sensor gear expansion amount correction part is configured to determine the amount of expansion due to the centrifugal force on the sensor gear corresponding to the calculated rotational speed of the rotor from the table.

According to a fifth aspect of the present invention, there is provided a motor comprising the motor control device of any one of the first to fourth aspects.

### BRIEF DESCRIPTION OF THE DRAWINGS

The objects, features, and advantages and other objects, features and advantages of the present invention will become more apparent from the following detailed description of the exemplary embodiments of the present invention illustrated in the accompanying drawings in which:

FIG. 1 is a block diagram schematically illustrating the motor control device according to an embodiment of the present invention.

FIG. 2 is a front view of the motor which is controlled by the motor control device illustrated in FIG. 1.

FIG. 3 is a graph illustrating the temperature characteristics of the output signal of a hall element.

FIG. 4A is a graph illustrating the output voltage of the magnetic sensor at a predetermined time after the start of operating the motor.

FIG. 4B is a graph illustrating the output voltage of the magnetic sensor at the start of operating the motor.

### DETAILED DESCRIPTION

Hereinafter, embodiments of the present invention will be described referring to the drawings. The same reference numerals for the same or corresponding constitutional elements are used over the drawings, with the meaning that these constitutional elements have the same function. Further, the scale of the drawings showing the constitutional elements of the illustrated embodiments has appropriately been adjusted so as to facilitate the understanding of the present inventions.

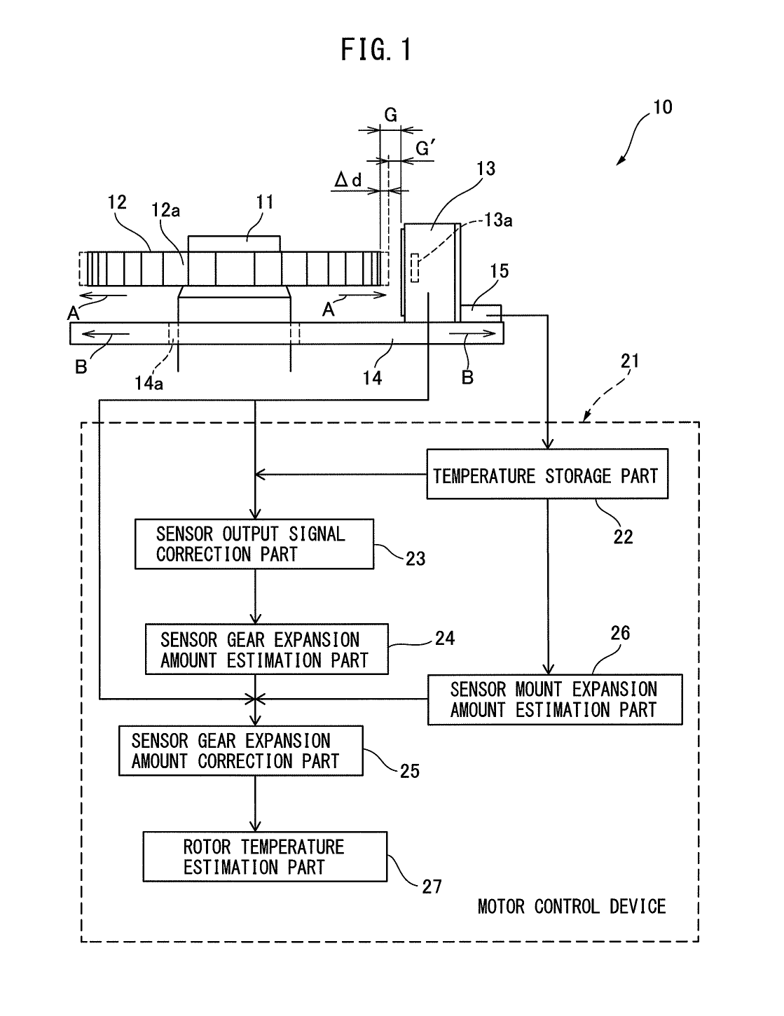

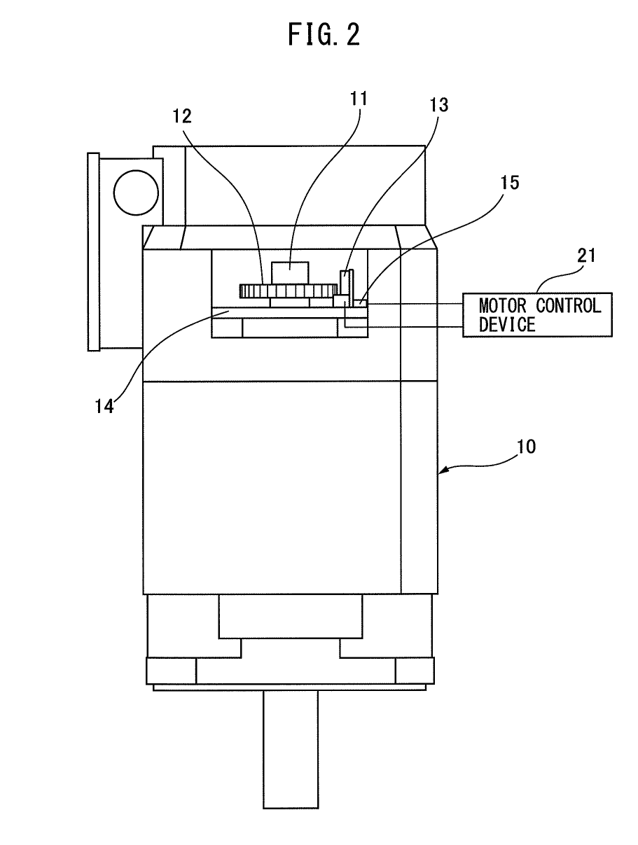

FIG. 1 is a block diagram schematically illustrating the motor control device according to an embodiment of the present invention. FIG. 2 is a front view of the motor which is controlled by the motor control device illustrated in FIG. 1.

With reference to FIGS. 1 and 2, a motor 10 of the present embodiment comprises a sensor gear 12 mounted on a rotor 11 of the motor 10, a magnetic sensor 13 which detects the presence/absence of each of a plurality of teeth 12a provided successively at predetermined intervals around the periphery of the sensor gear 12 as signals, a sensor mount 14 to which the magnetic sensor 13 is mounted, a temperature detector 15, for example, a thermistor, to detect the temperature of the sensor mount 14, and a motor control device 21. The motor 10 is, for example, a servo motor.

FIG. 1 illustrates that the magnetic sensor 13 mounted on the sensor mount 14 is arranged facing the outer peripheral part of the sensor gear 12 with a predetermined gap G therebetween. Further, the temperature detector 15 is provided on the sensor mount 14. Furthermore, the sensor mount 14 is supported by the motor main body (not illustrated), and a through-hole 14a is formed in the sensor mount 14. Moreover, the rotor 11 passes through the through-hole 14a without touching the sensor mount 14.

The magnetic sensor 13 comprises a hall element 13a, the output voltage of which changes in response to a change in the magnetic field. As the sensor gear 12 is made from a magnetic material, the magnetic field with respect to the hall element 13a changes with the presence or absence of the teeth 12a of the sensor gear 12 in a position facing the hall element 13. Accordingly, when one tooth of the plurality of teeth 12a of the sensor gear 12 is positioned opposite the hall element 13a, the hall element 13a of the magnetic sensor 13 outputs a detection signal (pulse signal) signifying the existence of the tooth 12a. Further, when the sensor gear 12 is rotating with the rotation of the rotor 11, the plurality of teeth 12a of the sensor gear 12 move so as to cross the front of the magnetic sensor 13, thus a signal is periodically output from the magnetic sensor 13. Accordingly, the motor control device 21 can acquire the rotational speed and position of the rotor 11 based on the frequency of the signal output from the magnetic sensor 13 of the motor 10. Namely, the magnetic sensor 13 is used as a rotary encoder.

Note that the motor control device 21 is configured to control the torque, the rotational speed and the rotational position, etc., of the rotor 11, based on the command value given to the motor 10 while monitoring the detected value of the magnetic sensor 13.

Further, the strength of the signal output from the aforementioned magnetic sensor 13 increases, the narrower the gap G, shown in FIG. 1, is between the sensor gear 12 and the magnetic sensor 13 and decreases the wider the gap G is. The present application makes to determine the size of the gap G based on the strength of the output signal of the magnetic sensor 13, by the use of the correlation between the gap G and the strength of the output signal of the magnetic sensor 13.

Further, in the present application, the motor control device 21 is provided with a function of estimating the temperature of the rotor 11. Namely, the motor control device 21 of the present application estimates the amount of thermal expansion of the sensor gear 12 based on the amount of change in the gap G determined by the strength of the output signal of the magnetic sensor 13 as described above, and the temperature of the sensor gear 12 is calculated from the estimated amount of thermal expansion. Further, it is considered that the temperature of the sensor gear 12 and the temperature of the rotor 11 are substantially the same, and thus the temperature of the sensor gear 12 is viewed as the temperature of the rotor 11.

Specifically, when the temperature of the rotor 11 due to the operation of the motor rises, both the sensor gear 12 and the sensor mount 14 expand due to heat. At this time, in the direction along the sensor mount 14, the sensor gear expands due to heat in the direction shown by the arrow A in FIG. 1, and the sensor mount 14 expands due to heat in a direction shown by the arrow B in FIG. 1. By such an expansion of both the rotor 11 and the sensor mount 14 due to heat, the gap G between the sensor gear 12 and the magnetic sensor 13 is reduced to gap G′. The change from gap G to gap G′, as previously stated, appears as a change in the strength of the output signal of the magnetic sensor 13. Therefore, the amount of change (Δd=G−G′) of the gap G can be calculated by the change in strength of the output signal of the magnetic sensor 13. The calculated amount of change Δd of the gap G can be assumed to be the thermal expansion of the sensor gear 12. Once the thermal expansion of the sensor gear 12 is known, the temperature of the sensor gear 12, that is, the temperature of the rotor 11, can be estimated from the thermal expansion coefficient of the material of the sensor gear 12.

However, the calculated amount of change Δd of the gap G is due to the thermal expansion of both the sensor gear 12 and the sensor mount 14. Namely, the gap G after thermal expansion includes the amount of thermal expansion of the sensor mount 14. Accordingly, in order to a more accurate estimation of the temperature of the rotor 11, it is necessary to determine the amount of expansion of the sensor gear 12 itself by subtracting the amount of thermal expansion of the sensor mount 14 from the calculated amount of change Δd of the gap G. Therefore, in the present invention, an accurate amount of expansion of the sensor gear 12 is determined, and based thereon; the temperature of the sensor gear 12, that is, the temperature of the rotor 11 is estimated.

In order to estimate the temperature of the rotor 11 accurately as described above, the motor control device 21, as shown in FIG. 1, comprises a temperature storage part 22, a sensor output signal correction part 23, a sensor gear expansion amount estimation part 24, a sensor gear expansion amount correction part 25, a sensor mount expansion amount estimation part 26, and a rotor temperature estimation part 27. These constituent parts will be sequentially described in detail as follows.

The temperature storage part 22 stores and holds the change in temperature of the sensor mount 14 detected by the temperature detector 15 over time. Specifically, the temperature storage part 22 acquires and stores the temperature around the temperature detector 15 at the start of operating the motor through the temperature detector 15, further, the temperature around the temperature detector 15 while the motor is in operation is sequentially taken at fixed intervals and stored.

The sensor output signal correction part 23 corrects the signal output from the magnetic sensor 13. The magnetic sensor 13 of the present embodiment is a sensor for detecting the presence/absence of the teeth 12a on the periphery of the sensor gear 12, by the hall element 13a.

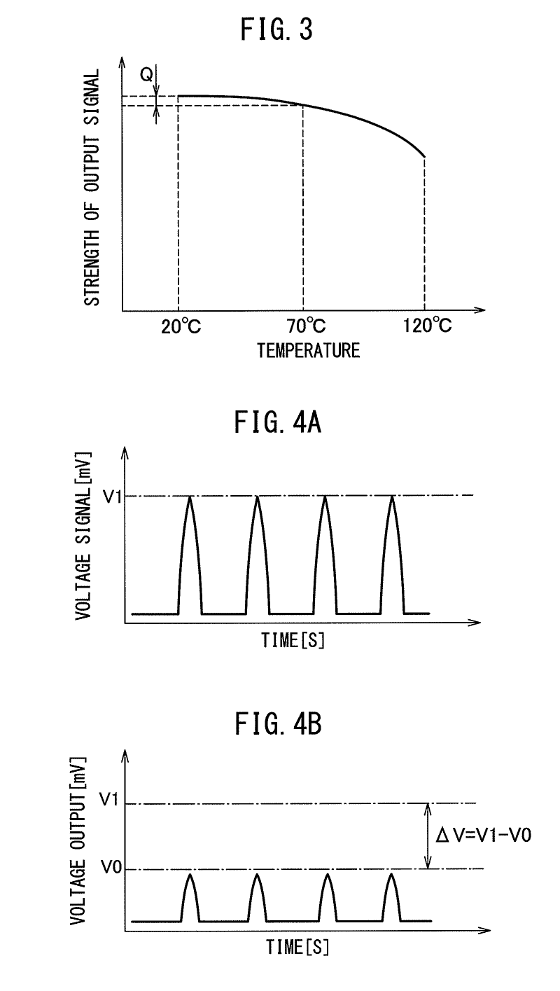

FIG. 3 is a graph illustrating the temperature characteristics of the output signal of the hall element 13a. Specifically, FIG. 3 illustrates the change in strength of the output signal of the hall element 13a when the temperature at the start of operating the motor is 20° C., the temperature after a predetermined time H from the start of operating the motor is 70° C., and the temperature after the further passage of time H is 120° C. As can be understood from the graph of FIG. 3, the strength of the output signal of the hall element 13a decreases with the increase in temperature of the magnetic sensor 13. In order to estimate the temperature of the rotor 11 with greater accuracy, the sensor output signal correction part 23 supplements the signal output from the magnetic sensor 13 with a signal reduction amount corresponding to the increase in temperature.

For example, as shown in FIG. 3, the reduction in signal strength of the hall element 13a due to the temperature rise is non-linear. Thus a table prepared beforehand showing the correlation between the signal strength of the hall element 13a and the temperature is stored and held in the sensor output signal correction part 23 beforehand. The sensor output signal correction part 23 acquires the temperature surrounding the temperature detector 15 (70° C. in FIG. 3) from the temperature storage part 22 after the passage of a predetermined time H from the start of operating the motor. Further, the sensor output signal correction part 23 determines a reduction amount of the signal strength (the signal reduction amount indicated by Q in FIG. 3), based on the acquired temperature with reference to the aforementioned table. Then, the sensor output signal correction part 23 supplements the signal output from the magnetic sensor 13 with the determined reduction amount of the signal strength.

Note that it is preferable for the temperature detector 15 to be arranged adjacent to the magnetic sensor 13. In this case, it is possible to create accurately a table indicating the correlation between the signal strength and the temperature as shown in FIG. 3. Further, in the present embodiment, the hall element 13a, whose strength of output signal decreases with the increase in temperature, is used as the magnetic sensor 13, and consequently the sensor output signal correction part 23 is provided. However, in case that an element whose output signal strength tends not to be affected by the temperature, for example, a magnetoresistive element, is used as the magnetic sensor 13, the motor control device 21 need not be provided with the sensor output signal correction part 23.

Next, the sensor gear expansion amount estimation part 24 estimates the amount of expansion of the sensor gear 12 from the amount of change of the output signal of the magnetic sensor 13. It is assumed that the output signal of the magnetic sensor 13 used herein has been corrected by the sensor output signal correction part 23. Further, the amount of expansion of the sensor gear 12 can be assumed to be the amount of change Δd (i.e. Δd=G−G′) of the gap G between the sensor gear 12 and the magnetic sensor 13 as shown in FIG. 1

FIG. 4A is a graph illustrating the output voltage of the magnetic sensor 13 when a predetermined time H has elapsed from the start of operating the motor. FIG. 4B is a graph illustrating the output voltage of the magnetic sensor 13 at the start of operating the motor.

The aforementioned amount of change Δd of the gap G may be determined from the change in the strength of signals that are output from the magnetic sensor 13, that is, the change in amplitude V of the voltage signal from the level indicated in FIG. 4B to that in FIG. 4A. At this time, it is preferable that the rotational speed Rw of the rotor 11 is fixed, because the amplitude V of the voltage signal of the magnetic sensor 13 is proportional to the speed Rw of the rotor 11.

When the operation of the motor is started at a certain rotational speed Rw, the amplitude of the voltage signal of the magnetic sensor 13 is V0 (hereinafter referred to as the “reference voltage”), as shown in FIG. 4B. It is assumed that when a predetermined amount of time H has elapsed from the start of the operation of the motor, the rotational speed Rw is maintained at a fixed speed, and the gap G between the sensor gear 12 and the magnetic sensor 13 has changed by Δd (i.e. Δd=G−G′). At this time, the amplitude of the voltage signal of the magnetic sensor 13 becomes V1 as shown in FIG. 4A, increasing from the reference voltage V0. As such, the amount of change of the amplitude of the voltage signal shown in FIG. 4B (i.e. ΔV=V1−V0) can be assumed to be proportional to Δd. That is, ΔV can be expressed as:

ΔV=k.Δd (1)

wherein k is a proportional constant. The value of the proportional constant k is acquired beforehand by experimentation or by simulations. Of course, the equation for expressing the correlation between ΔV and Δd is not limited to the above equation (1) and an equation for expressing the correlation between ΔV and Δd derived from experimentation or simulations may be used.

In the present embodiment, based on the aforementioned equation (1), the amount of change Δd of the gap G, that is, the assumed amount of expansion of the sensor gear 12, is calculated by the following equation (2):

Δd=ΔV/k (2)

wherein, the amount of change Δd of the gap G is due to the thermal expansion of both the sensor gear 12 and the sensor mount 14. Namely, the gap G′ after thermal expansion as shown in FIG. 1, includes the thermal expansion of the sensor mount 14.

Accordingly, the sensor gear expansion amount correction part 25 determines the amount of expansion of the sensor gear 12 itself, by subtracting the amount of expansion S of the sensor mount 14 from the calculated amount of change Δd of the gap G. In other words, the sensor gear expansion amount correction part 25 corrects the amount of change Δd of the gap G calculated by the above equation (2) to a more accurate value.

The amount of change Δd′ after the correction may be expressed as:

Δd′=Δd−S (3)

Note that, the sensor mount expansion amount estimation part 26 estimates the expansion amount S of the sensor mount 14 and outputs the value to the sensor gear expansion amount correction part 25. The amount of expansion S of the sensor mount 14, using the thermal expansion coefficient of the material of the sensor mount, can be expressed as the following equation (4):

S=R1·α1·ΔTa (4)

wherein R1 is the diameter [m] of the sensor mount 14, α1 is the thermal expansion coefficient of the material of the sensor mount 14 and ΔTa is the temperature rise [° C.] of the sensor mount 14.

The temperature rise ΔTa of the sensor mount 14 is the change in temperature detected by the temperature detector 15 on the sensor mount 14 from the start of operating the motor until the passage of a predetermined amount of time H and is acquired from the temperature storage part 22. Further, the values of the diameter R1 of the sensor mount 14 and the thermal expansion coefficient α1 are known values which can be acquired in the design stage of the motor, and it is preferable that the values are input into the equation (4) beforehand.

Next, the amount of change Δd of the gap G calculated by the above equation (2) and the amount of expansion S determined by the above equation (4), are assigned to the above equation (3) and the amount of change Δd′ after correction, namely the amount of expansion of the sensor gear 12 itself can be calculated.

Next, the rotor temperature estimation part 27 estimates the temperature of the sensor gear 12 from the expansion amount Δd′ of the sensor gear 12 itself, namely, estimates the temperature of the rotor 11. Specifically, the expansion amount Δd′ of the sensor gear 12, itself; by using the thermal expansion coefficient of the material of the sensor gear 12, can be expressed by the following equation (5):

Δd′=R2·α2·ΔTb (5)

wherein R2 is the diameter [m] of the sensor gear 12 [m], α2 is the thermal expansion coefficient of the material of the sensor gear 12 and ΔTb is the rise in temperature [° C.] of the sensor gear 12.

Further, the current temperature T1 of the sensor gear 12 can be expressed by the following equation using the temperature T0 of the sensor gear 12 at the start of operating the motor:

T1=T0+ΔTb (6)

The amount of increase in temperature ΔTb of the sensor gear 12 of the above equation (5) becomes:

ΔTb=Δd′/(R2·α2) (7)

Further, the rotor temperature estimation part 27 calculates the current temperature T1 of the sensor gear 12 by substituting ΔTb determined by the equation (7) in equation (6). When determining ΔTb by the above equation (7), Δd is calculated by the above equation (3) beforehand. Furthermore, the diameter R2 of the sensor gear 12 and the thermal expansion coefficient α2 are known values acquired in the design stage of the motor. Moreover, as the value of temperature T0 of the sensor gear 12 at the start of operating the motor, the temperature detected by the temperature detector 15 at the start of operating the motor is used.

Note that the rotor temperature estimation part 27 assumes that the calculated temperature T1 of the sensor gear 12 is the temperature of the rotor 11. This is because the sensor gear 12 is fitted to the rotor 11 by a tight fit, thus can be considered to have substantially the same temperature. However, if heat resistance exists between the mutually fit sensor gear 12 and rotor 11, it is preferable that the calculated temperature T1 of the sensor gear 12 be multiplied by a fixed correction coefficient to estimate the temperature of the rotor 11.

### Other Embodiments

Further, in the sensor gear expansion amount correction part 25, the amount of expansion S of the sensor mount 14 is subtracted from the estimated amount of expansion of the sensor gear estimated by the sensor gear expansion amount estimation part 24 (namely, the change in amount Δd of the gap G) to accurately determine the amount of expansion of the sensor gear 12 itself. However, in the present invention, it is preferable to consider the following feature to more accurately determine the amount of expansion of the sensor gear 12, itself.

Namely, the faster the rotational speed of the rotor 11, the greater the centrifugal force on the sensor gear 12. Further, the greater the centrifugal force on the sensor gear 12, the greater the amount of expansion of the sensor gear 12. Therefore, the amount of expansion of the sensor gear 12 due to the increase in temperature of the rotor 11 includes an amount of expansion due to centrifugal force on the sensor gear 12. Namely, the gap G′ after the thermal expansion shown in FIG. 1, not only includes the amount of thermal expansion of the sensor mount 14, but also includes the amount of expansion due to the centrifugal force on the sensor gear 12.

Accordingly, when determining the amount of expansion of the sensor gear 12, itself, that is, the amount of change Δd′, it is preferable not to use the aforementioned equation (3) but to use the following equation (8):

Δd′=Δd−S−L (8)

wherein, L is the amount of expansion caused by centrifugal force on the sensor gear 12.

A table showing the correlation between the amount of expansion L due to the centrifugal force on the sensor gear 12 and the rotational speed of the rotor 11 is prepared beforehand by experimentation or simulations and is recorded and stored in the sensor gear expansion amount correction part 25. Further, the rotational speed of the rotor 11 is calculated based on the frequency of the output signal of the magnetic sensor 13. Namely, the pulse signals output from the magnetic sensor 13 are counted and by finding the number of pulse signals output over a fixed time period the rotational speed of the rotor 11 can be calculated.

Accordingly, the sensor gear expansion amount correction part 25 shown in FIG. 1 acquires the rotational speed of the rotor 11 using the magnetic sensor 13, and with reference to the table indicating the correlation between the aforementioned amount of expansion L and the rotational speed, and thereby the amount of expansion L corresponding to the acquired rotational speed of the rotor 11 can be determined. Further by substituting into the aforementioned equation (8) the amount of expansion L determined as such, the amount of change Δd of the gap G calculated from the aforementioned equation (2), and the amount of expansion S determined by the aforementioned equation (4), a more accurate amount of expansion for the sensor gear 12 itself can be calculated.

In this way, the present application enables the accurate estimation of the temperature of the rotor 11 by accurately determining the amount of expansion of the sensor gear 12 itself by taking the thermal expansion of the sensor mount 14 and the expansion of the sensor gear 12 caused by centrifugal force into account. Namely, in the motor 10 where a rise in the temperature of the rotor 11 is accompanied by the rise in temperature of the sensor mount 14, the temperature of the rotor can be accurately estimated.

Note that in the aforementioned description of the embodiments, the motor 10 is a motor for a machine tool. However, the motor of the present invention is not limited to being the motor for a machine tool, but may be applied to drive the shafts of an industrial robot if used for machining.

Typical embodiments are illustrated above, however, the present invention is not limited thereto and without departing from the spirit of the invention it is possible to change the shapes, structures and materials etc. of the embodiments.

### EFFECTS OF THE ASPECTS OF THE INVENTION

According to the first aspect of the present invention, based on the amount of change in the strength of the output signal of the magnetic sensor positioned to leave a gap with the sensor gear, the amount of expansion of the sensor gear can be estimated. Further, if the amount of thermal expansion of the sensor gear is detected, the temperature of the sensor gear based on the thermal expansion coefficient of the material of the sensor gear, namely the temperature of the rotor can be estimated. Specifically, in the present application, from the temperature detected by the temperature detector attached to the sensor mount, the amount of expansion of the sensor mount is estimated, and the estimated amount of expansion of the sensor mount is subtracted from the estimated amount of expansion of the sensor gear. Accordingly, the estimated amount of expansion of the sensor gear can be corrected to a more accurate value. Therefore, in a motor in which the increase in temperature of the rotor accompanies the increase in temperature of the sensor mount, the temperature of the rotor can be accurately estimated.

Further, the temperature of the rotor can be estimated as described above by merely adding a simple temperature detector such as a thermistor to the sensor mount, and therefore, the motor can be provided without a large cost increase.

According to the second aspect of the present invention, if the strength of the output signal of the magnetic sensor has the property of decreasing with the increase in temperature, by correcting the strength of the output signal of the magnetic sensor based on the temperature, the temperature of the rotor can be estimated more accurately than in the first aspect.

According to the third and fourth aspects of the present invention, the amount of expansion due to centrifugal force on the sensor gear corresponding to the rotational speed of the rotor is subtracted from the estimated amount of expansion of the sensor gear, and therefore, the estimated amount of expansion of the sensor gear can be corrected to an even more accurate value than for the first aspect. Accordingly, the temperature of the rotor can be estimated more accurately than the aforementioned first and second aspects.

According to the fifth aspect, the temperature of the rotor of the motor can be accurately estimated, based on the accurate temperature of the rotor, and therefore, it is easy to control the motor to fix the output of the motor if the command is the same.

1. A motor control device controlling a motor which comprises a sensor gear mounted to a rotor of the motor; a magnetic sensor which detects the presence/absence of each of a plurality of teeth provided successively at predetermined intervals on the outer periphery of the sensor gear as signals; a sensor mount to which the magnetic sensor is mounted; and a temperature detector which detects the temperature of the sensor mount;
wherein
the motor control device comprises:
a sensor gear expansion amount estimation part which estimates the amount of expansion of the sensor gear based on the amount of change in the strength of the output signal of the magnetic sensor;
a sensor mount expansion amount estimation part which estimates the amount of expansion of the sensor mount based on the temperature detected by the temperature detector;
a sensor gear expansion amount correction part which corrects the estimated expansion of the sensor gear by subtracting the estimated expansion amount of the sensor mount from the estimated expansion amount of the sensor gear; and
a rotor temperature estimation part which estimates the temperature of the rotor based on the corrected expansion amount of the sensor gear.

2. The motor control device according to claim 1 further comprising:
a sensor output signal correction part which corrects the strength of the output signal of the magnetic sensor based on the temperature detected by the temperature detector,
wherein
the sensor gear expansion amount estimation part is configured to estimate the expansion amount of the sensor gear based on the amount of change in the strength of the output signal of the magnetic sensor corrected by the sensor output signal correction part.

3. The motor control device according to claim 1, wherein
the sensor gear expansion amount correction part is configured to correct the estimated amount of expansion of the sensor gear by subtracting the expansion amount due to the centrifugal force of the sensor gear corresponding to the rotational speed of the rotor and the estimated amount of expansion of the sensor mount, from the estimated amount of expansion of the sensor gear.

4. The motor control device according to claim 3, wherein
the rotational speed of the rotor is calculated based on the frequency of the output signal of the magnetic sensor, and
the sensor gear expansion amount correction part is configured to store and hold a table indicating the correlation between the expansion amount due to the centrifugal force on the sensor gear and the rotational speed of the rotor, and the sensor gear expansion amount correction part is configured to determine the amount of expansion due to the centrifugal force on the sensor gear corresponding to the calculated rotational speed of the rotor from the table.

5. A motor comprising the motor control device according to claim 1.
